(19) United States
(12) Patent Application Publication
(10) Pub. No.: US 2025/0037502 A1
(43) Pub. Date: Jan. 30, 2025

(54) PERSON ALERTS

(71) Applicant: Hewlett-Packard Development Company, L.P., Spring, TX (US)

(72) Inventor: Lee Warren Atkinson, Taipei City (TW)

(73) Assignee: Hewlett-Packard Development Company, L.P., Spring, TX (US)

(21) Appl. No.: 18/716,070

(22) PCT Filed: Dec. 10, 2021
(86) PCT No.: PCT/US2021/062882

§ 371 Date: Jun. 3, 2024

(51) Int. Cl. G06V 40/16; G08B 21/18

(52) U.S. Cl. CPC G06V 40/165; G06V 40/172; G08B 21/182

(57) ABSTRACT

In some examples, an electronic device includes a processor. In some examples, the processor detects whether a person is behind a user of the electronic device via a camera connected to the electronic device. In some examples, the processor determines an immersion level of the user. In some examples, the processor, in response to a determination that the immersion level is greater than an immersion threshold and a person is detected behind the user of the electronic device, provides a person alert to the user.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a diagram illustrating an example of person alerts for electronic devices;

FIG. 2 is a diagram illustrating an example of a camera view from an electronic device providing person alerts;

FIG. 3 is a block diagram illustrating an example of an electronic device for providing person alerts;

FIG. 4 is a block diagram illustrating an example of a computing device for providing person alerts;

FIG. 5 is a block diagram illustrating an example of memory for a computing device for providing person alerts;

FIG. 6 is a flow diagram illustrating an example of a method for providing person alerts for electronic devices; and

FIG. 7 is a block diagram illustrating an example of a computer-readable medium to provide person alerts for electronic devices.

### DETAILED DESCRIPTION

An electronic device is a device that includes electronic circuitry. For instance, an electronic device includes integrated circuitry (e.g., transistors, digital logic, semiconductor technology, etc.). Some examples of electronic devices include computing devices, laptop computers, desktop computers, and smartphones. An electronic device includes a display device. Privacy and security of information presented by the electronic device is a concern. For example, a user or organization may desire that the contents displayed on the screen of the display device are protected. In other examples, the electronic device may be used for communications (e.g., video conferences) in which sensitive information is displayed.

In some scenarios, a user may not be aware of surveillance or unauthorized viewing of the electronic device. For example, a person may look over the shoulder of the user to read the screen of the display device. In another example, a person may surreptitiously operate a recording device (e.g., a camera) to record the display device, thus compromising the security of the information displayed by the display device. In these examples, the surveillance of the electronic device may compromise the security and privacy of the user of the electronic device.

The user is more likely to be unaware of any surveillance or unauthorized viewing of the screen when the user is highly immersed with the electronic device or with an activity. For example, if the user is wearing headphones or the ambient sound is loud, the user is less likely to hear or be aware of a person behind them. By way of further example, if the user is highly engaged in an activity (e.g., rapid keystrokes, physically close to the display device, is talking, has high attention to the display), or if the user appears sleepy, the user's natural ability to sense another person may be compromised.

In some examples, an electronic device may have or be connected to a camera for capturing images or video. For example, the camera may be a built-in camera(s) or an external camera (e.g., web camera (webcam)). In some examples, the camera may be a user-facing camera used for capturing digital images, video conferencing and/or other applications.

In the examples described herein, the electronic device uses a camera to detect when a person is behind the user and detects when the user is immersed such that the user is less likely to be aware of the person behind them. If the electronic device detects a person behind the user and that the user's immersion level is such that any surveillance or unauthorized viewing may not be noticed by the user, the electronic device alerts the user of the person behind them to notify them of potential privacy concerns.

Throughout the drawings, similar reference numbers may designate similar or identical elements. When an element is referred to without a reference number, this may refer to the element generally, with or without limitation to any particular drawing or figure. In some examples, the drawings are not to scale, and the size of some parts may be exaggerated to more clearly illustrate the example shown. Moreover, the drawings provide examples in accordance with the description. The description is not limited to the examples provided in the drawings.

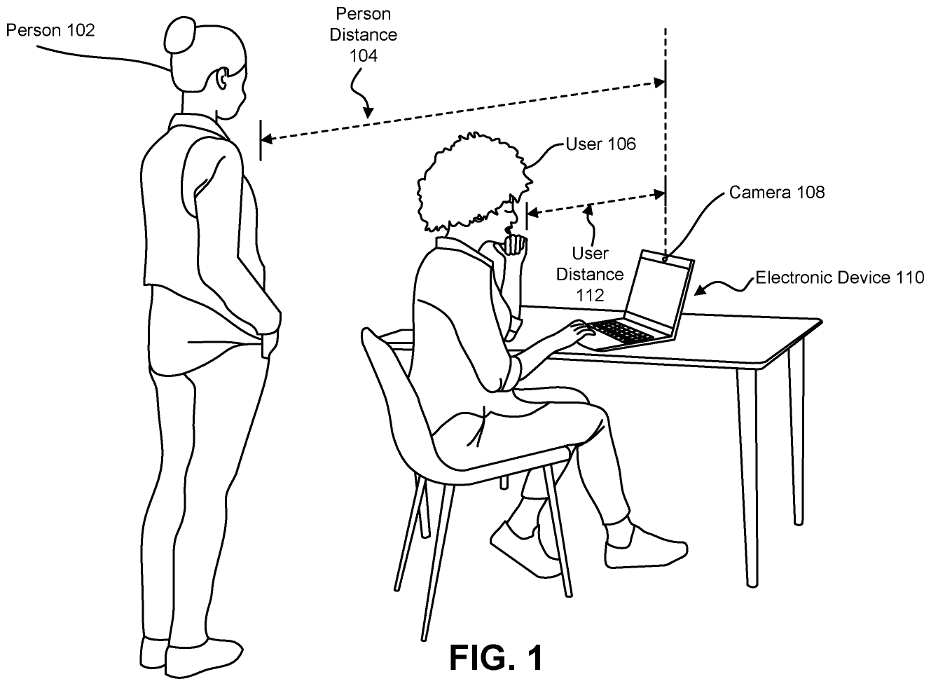

FIG. 1 is a diagram illustrating an example of person alerts for electronic devices. A user 106 of the electronic device 110 uses the electronic device 110 at a desk or table. The electronic device 110 detects whether a person 102 is behind a user 106 of the electronic device 110 via a camera 108 connected to the electronic device 110. In some examples, the camera 108 is part of the electronic device 110. In other examples, the camera 108 is connected to the electronic device 110 via a wired or wireless connection. In the example of FIG. 1, a person 102 is behind the user 106 of the electronic device 110.

The electronic device 110 determines an immersion level of the user 106. In some examples, an immersion level of the user 106 is an estimate or measurement of how engaged the user 106 is in the work on the electronic device 110, or how aware the user 106 is of the surroundings as an indicator of how likely the user 106 is aware of the person 102 behind the user 106. In response to a determination that the immersion level is greater than an immersion threshold and a person 102 is detected behind the user 106 of the electronic device 110, the electronic device 110 provides a person alert to the user 106. The person alert may be a visual or audible alert to the user 106.

In some examples, determining the immersion level of the user 106 includes determining how close the user 106 is to the electronic device 110. The closer the user 106 is to the electronic device 110, the more immersed the user 106 is. In other words, the distance between the user 106 and the electronic device 110 may have an inverse relationship with the level of immersion. For example, when the user distance 112 is six feet, the immersion level may be 30%. When the user distance 112 is three feet, the immersion level may be 60%. When the user distance 112 is 18 inches, the immersion level may be 85%. If the immersion threshold was 80%, when the user distance 112 is 18 inches, the immersion level of 85% has crossed the immersion threshold of 80%.

In some examples, the electronic device 110 uses a person distance 104 to detect whether a person 102 is behind the user 106 of the electronic device 110. The person distance 104 is the distance between the electronic device 110 and a person 102 behind the user 106. The electronic device 110 alerts the user 106 when the person distance 104 is close enough that the person 102 may be a privacy or security concern. For example, a person 102 may look over the shoulder of the user 106 to read the screen of the electronic device 110. In another example, a person 102 may surreptitiously operate a recording device (e.g., a camera) to record the electronic device 110, thus compromising the security of the information displayed by the electronic device 110. The electronic device 110 may use a person maximum distance to determine when the person 102 is of concern. When the person distance 104 is less than the person maximum distance, the electronic device 110 may determine that a person 102 is behind the user 106 of the electronic device 110. When the person distance 104 is greater than the person maximum distance, the electronic device 110 may determine that a person 102 is not behind the user 106 of the electronic device 110. The person maximum distance may change depending on the environment the electronic device 110 is in. For example, in a crowded airport, the person maximum distance may be five feet, but in a secluded area, the person maximum distance may be 25 feet.

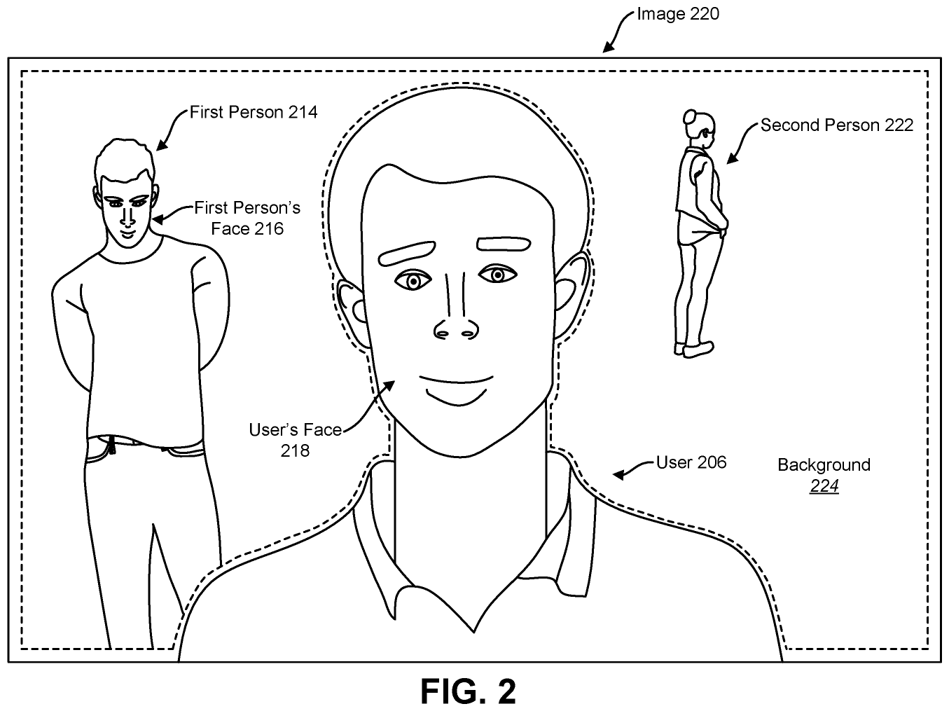

FIG. 2 is a diagram illustrating an example of a camera view from an electronic device providing person alerts. In some examples, the camera view of FIG. 2 is provided by a webcam on the electronic device 110. A user 206 of the electronic device 110 uses the electronic device having a camera. The camera 108 captures an image 220 of the user 206 and the scene or environment behind and/or around the user 206. The scene or environment behind and/or around the user 206 is the background 224. In FIG. 2, the background 224 is shown by the dotted line around the image 220 and the user 206. In some examples, any part of the image 220 that is not part of the user 206 is considered the background 224. In some examples, the image 220 is part of a video or video stream being provided by the camera 108.

The electronic device 110 detects faces in the image 220. In some examples, the electronic device 110 detects whether a face is present in the background 224 to detect whether a person is behind a user of the electronic device 110. In FIG. 2, a first person 214 is illustrated behind the user 206. The electronic device 110 detects the face 216 of the first person 214 to determine that a person is behind the user 206 of the electronic device. The image 220 also includes a second person 222. The second person 222 is facing away from the electronic device 110 and, as a result, the face of the second person 222 is not visible to the camera 108. As a result, the electronic device 110 may not consider the second person 222 a security or privacy concern. Because a background face has been detected (the first person's face 216), the electronic device 110 may generate a person alert on the electronic device if the immersion level is greater than an immersion threshold.

In some examples, the electronic device 110 determines an immersion level of the user 206 using the camera 108. The electronic device 110 detects the user's face 218. The size of the user's face 218 within the image 220 may be used in determining the user distance 112. The electronic device 110 detects the user's mouth and eyes. Determining the immersion level of the user 206 may include determining whether the user 206 is talking. In some examples, the user 206 talking is an immersion threshold such that if the user 206 is talking, the immersion level is greater than an immersion threshold. Determining the immersion level of the user 206 may include making an eye determination. In some examples, the electronic device 110 may determine whether eyes of the user 206 are closed as part of determining the immersion level.

In some examples, the electronic device 110 determines an immersion level of the user 206 using the camera 108 to perform object detection. The image 220 is analyzed to determine whether certain objects are in the image 220. For example, the electronic device 110 may perform object detection to determine whether the user 206 is wearing headphones to determine the immersion level of the user 206. In another example, the electronic device 110 may perform object detection to determine whether the user 206 is wearing a virtual reality headset to determine the immersion level of the user 206.

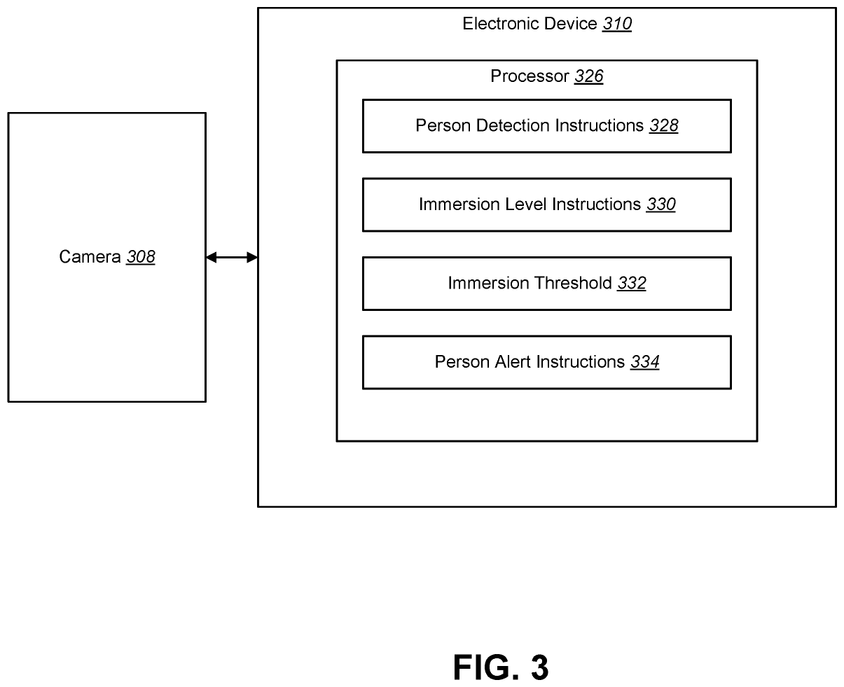

FIG. 3 is a block diagram illustrating an example of an electronic device 310 for providing person alerts. The electronic device 310 is an example of the electronic device 110 described in FIGS. 1-2. The electronic device 310 includes a processor 326 in electronic communication with a camera 308. The camera 308 may be part of the electronic device 310 or it may be a separate component connected to or coupled with the processor 326 via a wired or wireless connection for electronic communication between the camera 308 and the processor 326.

The processor 326 executes person detection instructions 328 causing the processor 326 to detect whether a person is behind a user of the electronic device 310 via the camera 308 connected to the electronic device 310. The processor 326 executes immersion level instructions 330 causing the processor 326 to determine the immersion level of the user. In response to a determination that the immersion level is greater than an immersion threshold 332 and a person is detected behind the user of the electronic device 310, the processor 326 executes person alert instructions 334 causing the processor 326 to provide a person alert to the user.

An electronic device 310 is a device that includes electronic circuitry (e.g., integrated circuitry). Examples of electronic devices may include computing devices (e.g., laptop computers, desktop computers, all-in-one computers, tablet devices, etc.), smartphones, game consoles, game controllers, smart appliances, printing devices, vehicles with electronic components, aircraft, drones, robots, smart appliances, etc.

In some examples, electronic devices utilize circuitry (e.g., controller(s), processor(s), etc., or a combination thereof) to perform an operation. In some examples, electronic devices execute instructions stored in memory to perform the operation(s). Instructions may be code, programming, or a combination thereof that specifies functionality or operation of the circuitry. In some examples, different circuitries in an electronic device store or utilize separate instructions for operation. Portions of the electronic device 310 are coupled or connected via an interface (e.g., bus(es), wire(s), connector(s), etc.). For example, portions of the electronic device 310 or circuitries of the electronic device 310 may be coupled via an inter-integrated circuit (I2C) interface. The portions or circuitries may communicate via the interface.

The processor 326 executes instructions or code to perform operations on the electronic device 310. The processor 326 may be any of a microcontroller (e.g., embedded controller), a central processing unit (CPU), a semiconductor-based microprocessor, a general-purpose processor, graphics processing unit (GPU), field-programmable gate array (FPGA), an application-specific integrated circuit (ASIC), a circuit, a chipset, and/or other hardware device suitable for retrieval and execution of instructions stored in a memory (not shown). While a single processor 326 is shown in FIG. 3, in other examples, the processor 326 may include multiple processors (e.g., a CPU and a GPU).

The electronic device 310 may include additional portions (e.g., components, circuitries, etc.) (not shown) or some of the portions described herein may be removed or modified without departing from the scope of this disclosure. In some examples, the electronic device 310 may include input/output (I/O) circuitry (e.g., port(s), interface circuitry, etc.), memory circuitry, input device(s), output device(s), etc., or a combination thereof.

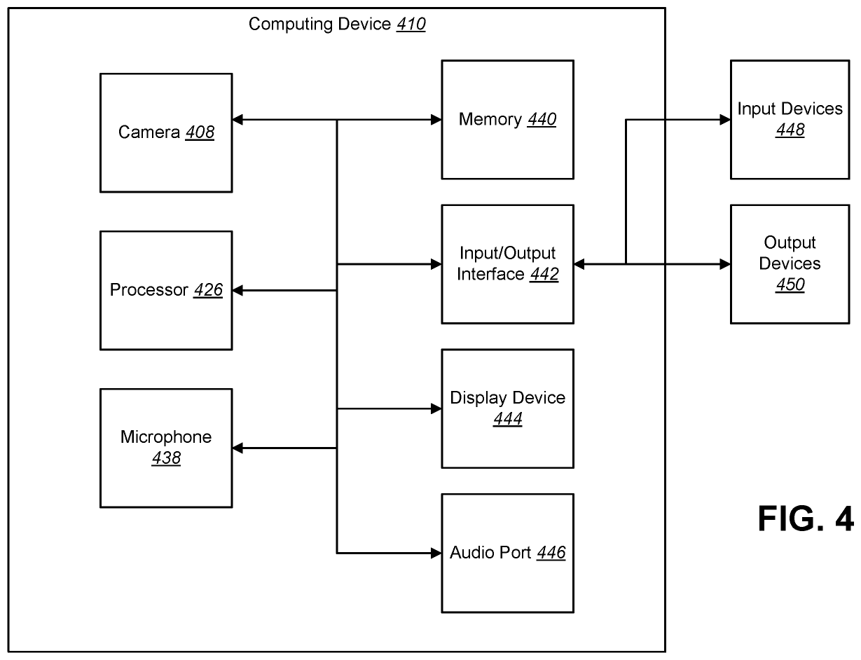

FIG. 4 is a block diagram illustrating an example of a computing device 410 for providing person alerts. In some examples, the computing device 410 may perform an aspect of the operations described in FIGS. 1-3. The computing device 410 may be an example of the electronic devices 110, 310 described in FIGS. 1-3. In some examples, the computing device 410 includes a processor 426 in communication with memory 440, a display device 444, a camera 408, a microphone 438, an audio port 446, and an input/output interface 442. In some examples, portions of the computing device 410 are coupled via an interface (e.g., bus(es), wire(s), connector(s), etc.). Examples of the computing device 410 include a desktop computer, laptop computer, tablet device, smartphone, mobile device, etc. In some examples, one, some, or all of the components or elements of the computing device 410 may be structured in hardware or circuitry. In some examples, the computing device 410 may perform one, some, or all of the operations described in FIGS. 1-7.

The computing device 410 is coupled to or is in electronic communication with the camera 408 to identify a user of the computing device 410. In some examples, an immersion level of the user is determined and a person alert is generated on the computing device 410 when the immersion level is greater than a threshold and when a background person is detected or when a background face is detected. The camera 408 is also used to detect whether a face is present in the background 224. In some examples, the camera 408 may be integrated with the computing device 410. For example, in the case of a laptop computer, a tablet computer, or a smartphone, the camera 408 may be built into the computing device 410. In other examples, the camera 408 may be separate from the computing device 410 but may communicate with the computing device 410. For example, an external webcam may be connected to the computing device 410.

The camera 408 may be positioned to view the user of the computing device 410. For example, the camera 408 of a laptop computer may view the user when the case of the laptop computer is open. In this scenario, the camera 408 may be located in a frame of the case housing the display device 444 of the laptop computer. In other examples, the camera 408 may be a front-facing camera of a tablet computer or smartphone. In yet other examples, the camera 408 may be a webcam or other external camera positioned to view the user of the computing device 410.

In some examples, input/output devices 448, 450 are used to determine the immersion level of the user. The audio port 446 may be used to determine the immersion level of the user. One example of an audio port 446 is a headphone jack. In some examples, whether headphones are plugged into the audio port 446 and the sound level being played over the headphones are used in determining the immersion level of the user. Determining the immersion level of the user may include using the microphone 438 to measure the ambient sound level. The louder the sound level is, the more likely that the user may be unaware of persons behind the user. The microphone 438 is used to determine whether an ambient sound level is above an ambience threshold. A keyboard may also be used to determine the immersion level of the user. Determining the immersion level of the user may consider whether the user is typing on a keyboard and whether a typing rate of the user is greater than a typing threshold. More generally, input devices 448 may be used in determining the immersion level by determining whether the input device 448 is in use and by determining whether a usage rate of the input device 448 coupled to the computing device 410 is greater than a usage rate threshold.

The processor 426 execute instructions on the computing device 410 to perform an operation (e.g., execute application(s)). For instance, the processor 426 may be an example of the processor 326 described in FIG. 3. In other examples, the processor 426 may be a processor from the AMD architecture or a processor from the Intel architecture. The processor 426 is in electronic communication with the memory 440 via a memory communications bus.

In some examples, the memory 440 includes memory circuitry. The memory circuitry may be electronic, magnetic, optical, or other physical storage device(s) that contains or stores electronic information (e.g., instructions, data, or a combination thereof). In some examples, the memory circuitry stores instructions for execution (by the processor 426, or other component(s) of the computing device 410, or a combination thereof). The memory circuitry may be integrated into or separate from the element(s) described in FIG. 4. The memory circuitry may be, for example, Random Access Memory (RAM), Electrically Erasable Programmable Read-Only Memory (EEPROM), storage device(s), optical disc(s), or the like. In some examples, the memory circuitry may be volatile memory, non-volatile memory, or a combination thereof. Examples of memory circuitry may include Dynamic Random Access Memory (DRAM), EEPROM, magnetoresistive random-access memory (MRAM), phase change RAM (PCRAM), memristor, flash memory, or the like. In some examples, the memory circuitry may be non-transitory tangible machine-readable or computer-readable storage media, where the term “non-transitory” does not encompass transitory propagating signals.

The computing device 410 includes a user interface. A user interface includes input devices 448 and output devices 450. Examples of output devices 450 include a display device 444, speaker(s), headphone(s), etc. The display device 444 may be referred to as a monitor, touchscreen, screen, or display of the computing device 410. In some examples, the display device 444 includes circuitry and/or instructions for presenting information to a user. In some examples, a display device 444 is attached to or may be external from the computing device 410. Some examples of technologies used by the display device 444 include an electroluminescent (ELD) display, a liquid crystal display (LCD), light-emitting diode (LED) backlit LCD, thin-film transistor (TFT) LCD, light-emitting diode (LED) display (e.g., organic light-emitting diode (OLED)), active-matrix LED (AMOLED) display, plasma (PDP) display, and/or quantum dot (QLED) display.

The user interface also includes input devices 448. Examples of input devices 448 include a keyboard, a mouse, a touch screen, joystick, camera 408, microphone 438, etc. The input/output interface 442 provides an interface between the processor 426 and the input devices 448 and output devices 450. For example, the input/output interface 442 may be a Universal Serial Bus (USB) port for a keyboard or a mouse. In another example, the input/output interface 442 may be a video card for an external display device 444. In some examples, the person alert is provided to the user through the user interface.

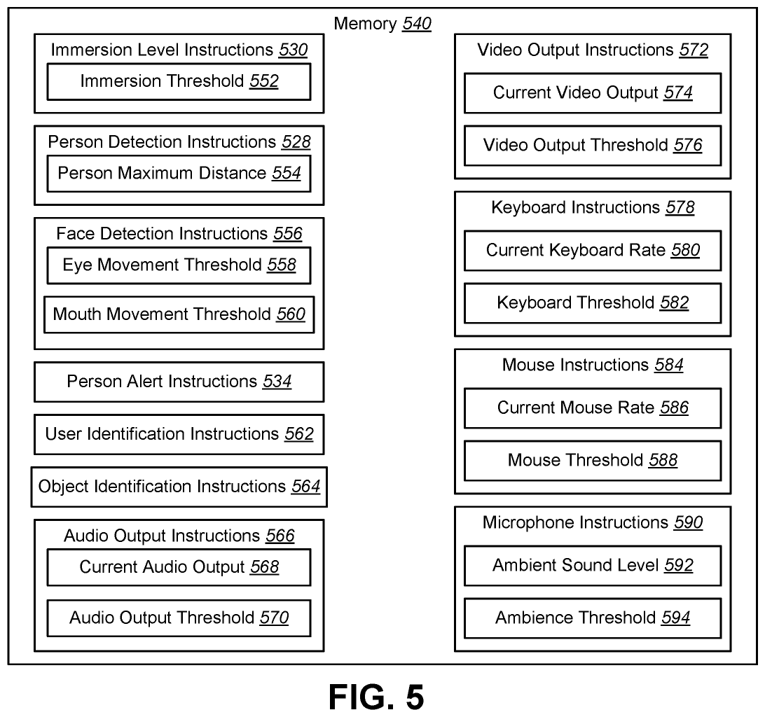

FIG. 5 is a block diagram illustrating an example of memory 540 for a computing device 410 for providing person alerts. The memory 540 is an example of the memory 440 described in FIG. 4. The instructions are executable by the processor 426 and are examples of instructions and operations described in FIGS. 1-4.

In some examples, the immersion level instructions 530 are instructions that when executed cause the processor 426 to determine the immersion level of the user. The immersion level instructions 530 also determine whether the immersion level is greater than an immersion threshold 552. In some cases, the immersion level instructions 530 may also determine whether the immersion level is less than an immersion threshold 552. The thresholds below are examples of immersion thresholds 552 for a particular device, interface, or measurement.

In some examples, the person detection instructions 528 are instructions that when executed cause the processor 426 to detect whether a person is behind the user. The person detection instructions 528 may use a person maximum distance 554 to determine whether a person behind the user is close enough to the user to cause an alert if the user's immersion level warrants a person alert.

In some examples, the face detection instructions 556 are instructions that when executed cause the processor 426 to detect a face in an image 220. The face detection instructions 556 may be used in combination with the person detection instructions 528. The face detection instructions 556 may determine whether a head of the user is lowered, which may indicate that the user is engaged with the computing device 410 if the face of the user is looking at the display device 444, or which may indicate that the user is sleepy or tired if the user is looking down and the face is not visible to the camera 408. An eye movement threshold 558 indicates thresholds for eye movement such as open, closed, an eye blinking rate, how long an eye gaze remains in a certain spot, the eyebrows are squeezed together, raised eyebrows, eyelids narrowed, droopy eyelids, etc. A mouth movement threshold 560 indicates thresholds for mouth movement such as open, closed, movement, or speech-type movement.

The person alert instructions 534 are instructions that when executed cause the processor 426 to provide a person alert to the user. The alert is provided to the user through an output device on the computing device 410. For example, the alert may be provided on the display device 444 and/or through an audio output device.

In some examples, the user identification instructions 562 are instructions that when executed cause the processor 426 to identify the user of the computing device 410. The user identification instructions 562 when executed may also cause the processor 426 to determine the amount the user is moving. Object identification instructions 564 are instructions that when executed cause the processor 426 to identify objects in the image 220. For example, the object identification instructions 564 may identify whether the user is wearing headphones or a virtual reality headset.

In some examples, the audio output instructions 566 are instructions that when executed cause the processor 426 to determine the status and use of the audio port 446 of the computing device 410 to be used in determining the immersion level. The current audio output 568 indicates whether an audio output device, such as headphones, is plugged into the audio port 446. The current audio output 568 may also indicate whether an audio port 446 on the computing device 410 is in use. The current audio output 568 may also indicate the current volume setting. The audio output threshold 570 is the threshold for determining whether a user is immersed based on information from the audio output. The audio output threshold 570 may be a boolean setting such as if headphones are plugged in or not. The audio output threshold 570 may also be a volume setting indicating that if the volume on the audio output is above this volume setting, then the immersion threshold 552 has been passed. For example, if the audio output threshold 570 is 80%, when the current audio output 568 has passed 80% of the maximum volume, the immersion level is greater than an immersion threshold 552.

In some examples, the video output instructions 572 are instructions that when executed cause the processor 426 to determine the status and use of the video port of the computing device 410 to be used in determining the immersion level. The current video output 574 indicates what video or video streams are currently being played or are running on the computing device 410. For example, the current video output 574 indicates if the computing device 410 is playing a movie, streaming video, in a virtual meeting, etc. The video output threshold 576 is the threshold for determining whether a user is immersed based on information from the video output. The video output threshold 576 may be based on the type of content being shown on the display device 444. For example, if the video output threshold 576 lists a movie or a virtual meeting, when the current video output 574 is a movie or a virtual meeting, the immersion level is greater than an immersion threshold 552.

In some examples, the keyboard instructions 578 are instructions that when executed cause the processor 426 to determine the current usage of the keyboard. The keyboard instructions 578 may determine whether the user is typing on a keyboard connected to the computing device 410 and whether a typing rate of the user is greater than a typing threshold. Based on whether the current keyboard rate 580 is higher than the keyboard threshold 582, the immersion level may be greater than the immersion threshold 552. Little or no user input may indicate that the user is fatigued, sleeping, or generally unaware of any of the user's surroundings.

In some examples, the mouse instructions 584 are instructions that when executed cause the processor 426 to determine the current usage of the mouse. Based on whether the current mouse rate 586 is higher than the mouse threshold 588, the immersion level may be greater than the immersion threshold 552. More generally, any input device 448 may be used to determine the immersion level of the user. The computing device 410 may monitor and then determine whether a usage rate of an input device 448 coupled to the computing device 410 is greater than a usage rate threshold.

In some examples, the microphone instructions 590 are instructions that when executed cause the processor 426 to determine the ambient sound level 592 using the microphone 438. If the current ambient sound level 592 is greater than an ambience threshold 594, then the immersion level is greater than the immersion threshold 552.

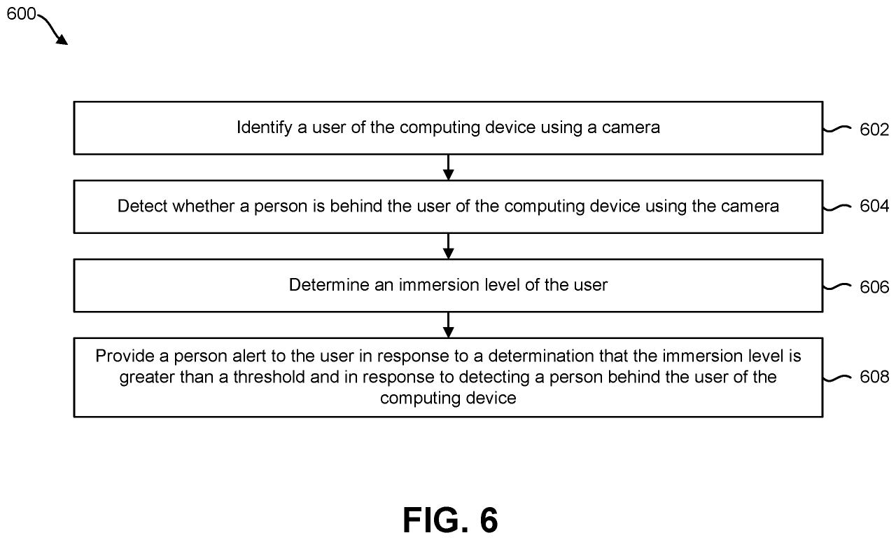

FIG. 6 is a flow diagram illustrating an example of a method 600 for providing person alerts for electronic devices. The method 600 or a method 600 element(s) is performed by an electronic device, computing device or apparatus (e.g., electronic device, apparatus, desktop computer, laptop computer, smartphone, tablet device, etc.). For example, the method 600 is performed by the electronic device 310 described in FIG. 3 or by the computing device 410 described in FIG. 4.

At 602, the computing device 410 identifies a user of the computing device using a camera 408. At 604, the computing device 410 detects whether a person is behind the user of the computing device 410 using the camera 408. The various techniques described herein for determining whether a person is behind the user of the computing device 410 may be used. At 606, the computing device 410 determines an immersion level of the user. As described above, input and output devices 448, 450 of the computing device 410 are used to determine the immersion level of the user. At 608, the computing device 410 provides a person alert to the user in response to a determination that the immersion level is greater than a threshold and in response to detecting a person behind the user of the computing device 410.

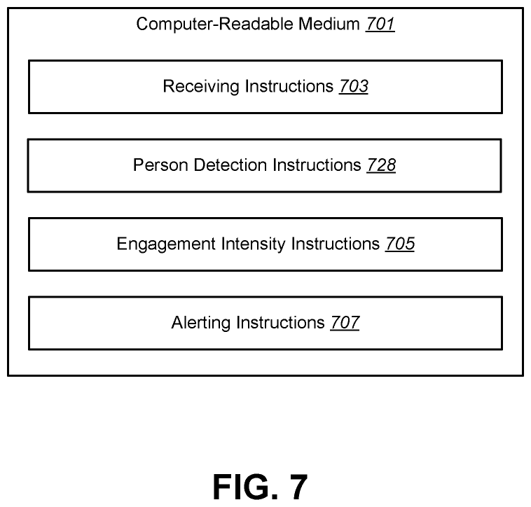

FIG. 7 is a block diagram illustrating an example of a computer-readable medium 701 to provide person alerts for electronic devices. The computer-readable medium 701 is a non-transitory, tangible computer-readable medium 701. The computer-readable medium 701 may be, for example, RAM, EEPROM, a storage device, an optical disc, and the like. In some examples, the computer-readable medium 701 may be volatile and/or non-volatile memory, such as DRAM, EEPROM, MRAM, PCRAM, memristor, flash memory, and the like. In some examples, the computer-readable medium 701 described in FIG. 7 may be an example of memory for an electronic device 310 or a computing device 410 described herein. In some examples, code (e.g., data and/or executable code or instructions) of the computer-readable medium 701 may be transferred and/or loaded to memory or memories of the electronic device 310 or the computing device 410.

The computer-readable medium 701 includes code (e.g., data and/or executable code or instructions). For example, the computer-readable medium 701 includes receiving instructions 703, person detection instructions 728, engagement intensity instructions 705, and alerting instructions 707.

In some examples, the receiving instructions 703, are instructions that when executed cause the processor 326 of the electronic device 310 to receive images and/or a video stream from a camera 308 connected to the electronic device 310.

In some examples, the person detection instructions 728 are instructions that when executed cause the processor 326 to detect whether a person is behind the user as described herein. The engagement intensity instructions 705 are instructions that when executed cause the processor 326 to determine the engagement intensity of the user. The engagement intensity is a measurement or determination of how engaged the user is which may have an inverse relationship to how aware the user is of the surroundings and environment.

The alerting instructions 707 are instructions that when executed cause the processor 326 to generate an alert. The alert may be provided directly to the user through an output device, indirectly to the user through an electronic message sent via a global communications network, or to another recipient sent via a global communications network.

As used herein, items described with the term “or a combination thereof” may mean an item or items. For example, the phrase “A, B, C, or a combination thereof” may mean any of: A (without B and C), B (without A and C), C (without A and B), A and B (without C), B and C (without A), A and C (without B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

1. An electronic device, comprising:
a processor to:
detect whether a person is behind a user of the electronic device via a camera connected to the electronic device;
determine an immersion level of the user; and
in response to a determination that the immersion level is greater than an immersion threshold and a person is detected behind the user of the electronic device, provide a person alert to the user.

2. The electronic device of claim 1, wherein detecting whether a person is behind a user of the electronic device comprises detecting a face.

3. The electronic device of claim 1, wherein determining the immersion level of the user comprises detecting headphones on the user using a camera connected to the electronic device.

4. The electronic device of claim 1, wherein determining the immersion level of the user comprises determining whether an audio port on the electronic device is in use.

5. The electronic device of claim 1, wherein determining the immersion level of the user comprises using a microphone connected to the electronic device.

6. The electronic device of claim 5, wherein determining whether the immersion level is greater than the immersion threshold comprises determining whether an ambient sound level is above an ambience threshold.

7. A computing device, comprising:
a camera; and
a processor to:
identify a user of the computing device using the camera;
detect whether a face is present in a background using the camera;
determine an immersion level of the user; and
generate a person alert on the computing device when the immersion level is greater than an immersion threshold and when a background face is detected.

8. The computing device of claim 7, wherein determining the immersion level of the user comprises determining whether the user is typing on a keyboard connected to the computing device.

9. The computing device of claim 7, wherein determining when the immersion level is greater than the immersion threshold comprises determining whether a typing rate of the user is greater than a typing threshold.

10. The computing device of claim 7, wherein determining when the immersion level is greater than the immersion threshold comprises determining whether a usage rate of an input device connected to the computing device is greater than a usage rate threshold.

11. The computing device of claim 7, wherein determining the immersion level of the user comprises determining whether the user is talking.

12. The computing device of claim 7, wherein determining the immersion level of the user comprises making an eye determination.

13. A non-transitory tangible computer-readable medium comprising instructions when executed cause a processor of an electronic device to:
receive an image from a camera connected to the electronic device;
detect whether a person is behind a user of the electronic device based on the image;
determine an engagement intensity of the user of the electronic device based on an input in electronic communication with the electronic device; and
cause an alert in response to a determination that the engagement intensity is greater than an immersion threshold and a person is detected behind the user of the electronic device.

14. The non-transitory tangible computer-readable medium of claim 13, wherein determining the engagement intensity of the user comprises performing object detection on the image.

15. The non-transitory tangible computer-readable medium of claim 13, wherein determining the engagement intensity of the user comprises determining a user distance from the electronic device.
